(19) United States
(12) Patent Application Publication
(10) Pub. No.: US 2010/0118096 A1
(43) Pub. Date: May 13, 2010

(54) IMAGE FORMING APPARATUS

(75) Inventors: Akihiro Mouri, Fuchu-shi (JP); Hiroshi Taniuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/613,470

(22) Filed: Nov. 5, 2009

(30) Foreign Application Priority Data
Nov. 7, 2008 (JP) 2008-286724

(51) Int. Cl. B41J 2/01

(52) U.S. Cl. 347/102

(57) ABSTRACT

An image forming apparatus includes an image forming unit configured to form an image by using liquid, a conveyance mechanism having a roller configured to convey a medium on which the image is formed by the image forming unit or a transfer belt for transferring to a medium an intermediate image formed by the image forming unit, and wherein the roller has a discharge surface on which one or a plurality of holes is formed to blow gas toward the medium or the transfer belt conveyed by the conveyance mechanism.

### BACKGROUND OF THE INVENTION

1. Field of the Invention

The present invention relates to an image forming apparatus which forms an image using liquid.

2. Description of the Related Art

In an inkjet type or liquid development type (silver halide photograph type) image forming apparatus, since liquid is applied to a sheet-shaped recording medium (hereinafter simply referred to as “medium”) in the image forming process, there needs to be a drying process for drying such a wet medium. To improve print throughput, the drying process has to be finished for a shorter time. U.S. Pat. No. 5,410,382 discusses a drying apparatus for blowing hot air to a wet medium after the liquid development process to accelerate drying.

The apparatus discussed in the above document achieves effective acceleration of drying by providing a supply chamber with blowout ports for blowing hot air to a surface of the medium from a close position and by positioning each of the blowout ports between a plurality of conveyance rollers. However, when the supply chamber is provided between rollers as described above, a size and cost of the apparatus may be increased. Therefore, improvement needs to be made in this regard.

### SUMMARY OF THE INVENTION

The present invention is directed to an image forming apparatus capable of drying, for a short time, a medium or a transfer belt which gets wet through an image forming process while suppressing cost increase and upsizing of the apparatus.

According to an aspect of the present invention, an image forming apparatus includes an image forming unit configured to form an image by using liquid, a conveyance mechanism having a roller configured to convey a medium on which the image is formed by the image forming unit or a transfer belt for transferring to a medium an intermediate image formed by the image forming unit, and wherein the roller has a discharge surface on which one or a plurality of holes is formed to blow gas toward the medium or the transfer belt conveyed by the conveyance mechanism.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an image forming apparatus according to a first exemplary embodiment of the present invention.

FIGS. 2A, 2B, and 2C illustrate a medium which is conveyed in a dry box.

FIG. 3 is a block diagram illustrating a configuration of a control unit.

FIG. 4 is a flow chart illustrating processing procedure of the image forming apparatus according to the first exemplary embodiment.

FIG. 5 illustrates a structural example of a roller that blows air.

FIG. 6 illustrates an image forming apparatus according to a second exemplary embodiment of the present invention.

FIG. 7 is a flow chart illustrating processing procedure of the image forming apparatus according to the second exemplary embodiment.

### DESCRIPTION OF THE EMBODIMENTS

Various exemplary embodiments, features, and aspects of the invention will be described in detail below with reference to the drawings.

An image forming apparatus according to a first exemplary embodiment of the present invention conveys a roll-shaped medium, forms an image by supplying ink from an inkjet type recoding head directly to the medium, and dries an ink on the medium by a drier. In the present specification, the “medium” is any sheet-shaped recording medium such as paper, fabric, plastic sheet or film.

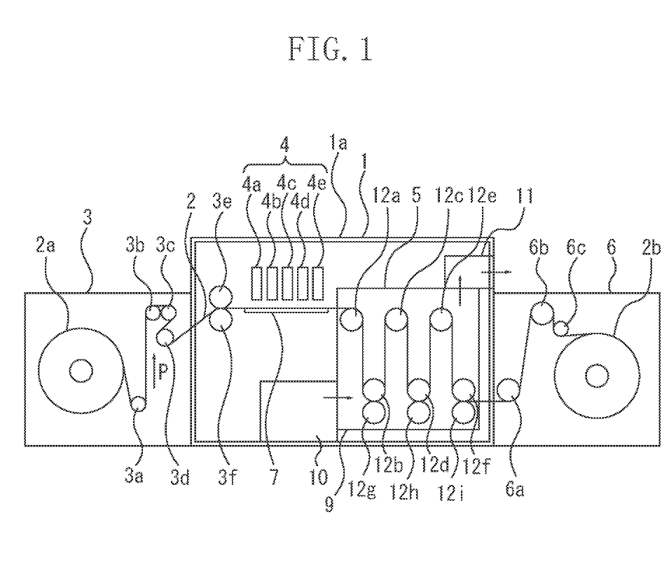

FIG. 1 illustrates the image forming apparatus according to the first exemplary embodiment of the present invention. In FIG. 1, a roll-shaped medium 2 is wound on a supply roll 2a and a winding roll 2b. The medium 2 has a width of 400 mm, of which 40 mm at each end forms a non-image forming area. The supply roll 2a and the winding roll 2b are rotated in the clockwise direction by a motor. In the present exemplary embodiment, though the medium 2 is a roll sheet, it may be a cut sheet.

The image forming apparatus 1 includes a medium supply unit 3 configured to supply a medium, an image forming unit 4, a dryer 5, and a medium winding unit 6 configured to wind the medium on which an image is formed. The medium supply unit 3 includes rollers 3a to 3d configured to convey the medium 2. Between the medium supply unit 3 and the image forming unit 4, rollers 3e and 3f configured to convey the medium 2 are arranged. The medium winding unit 6 includes rollers 6a to 6c configured to convey the medium 2. The image forming unit 4 includes recording heads 4a to 4e, which face a platen 7.

In the image forming apparatus 1, when recording on a surface of the medium 2 is performed, the medium 2 is drawn from the supply roll 2a in the direction of an arrow P in FIG. 1 and conveyed by the rollers 3a to 3f to a position where the medium 2 faces the recording heads. The Image forming unit 4 includes inkjet recording heads configured to discharge reaction liquid and aqueous ink toward the medium 2 in response to an image forming signal.

An inkjet system includes various systems such as a system using a heating element, a system using a piezoelectric element, a system using a micro-electro-mechanical systems (MEMS) element, and a system using an electrostatic element, and any of these systems may be adopted here. The recording heads include a recording head 4a configured to discharge the reaction liquid, a recording head 4b configured to discharge a black (K) ink, and a recording head 4c configured to discharge a cyan (C) ink. The recording heads further include a recording head 4d configured to discharge a magenta (M) ink, and a recording head 4e configured to discharge a yellow (Y) ink. The recording heads 4a to 4e are arranged in a width direction of the medium with their nozzles positioned with a 1200 dpi pitch. Instead of the reaction liquid discharged from the recording head, the reaction liquid may be applied to the medium by a rotogravure roll, a spray, a blade or the like. Further, in addition to combined use of the reaction liquid and aqueous ink, the aqueous ink may be only used to form an image without use of the reaction liquid.

The medium on which an image is formed with the reaction liquid and aqueous ink discharged from the recording heads 4a to 4e is conveyed to the dryer 5 where water evaporates from the image formed on the medium. The dryer 5 includes a dry box 9 with an inlet port and an outlet port for the conveyed medium, a hot air blower 10, and an exhaust portion 11. Further, the dryer 5 includes rollers 12a to 12i that are conveyance mechanism configured to convey the medium 2 in the dry box 9.

The rollers 12a to 12f are conveyance rollers which are synchronously driven by a common drying source. The rollers 12g, 12h, and 12i are driven rollers which are respectively rotated by the rollers 12b, 12d, and 12f. The rollers 12b, 12d, and 12f are in contact with a print surface of the medium and the other rollers 12a, 12c, 12e, 12g, 12h, and 12i are in contact with a back surface of the print surface of the medium.

The dry box 9 hermetically surrounds a plurality of the conveyance rollers that constitute a conveyance mechanism. In the dry box 9, the medium is conveyed along a serpentine path. A conveyance path of the medium inside the dry box is about 3 m. The conveying speed of the medium 2 is 300 mm/sec.

The hot air blower 10 blows hot air to the whole of the dry box 9, and each tube connected to the rollers 12b, 12d, and 12f, described below. In the dry box 9, water evaporated from the medium 2 is discharged from the dry box 9 via the exhaust portion 11 to the outside of the image forming apparatus 1. The medium 2 dried by the dryer 5 is conveyed by the rollers 6a to 6c and wound up by the winding roll 2b with the image formed thereon.

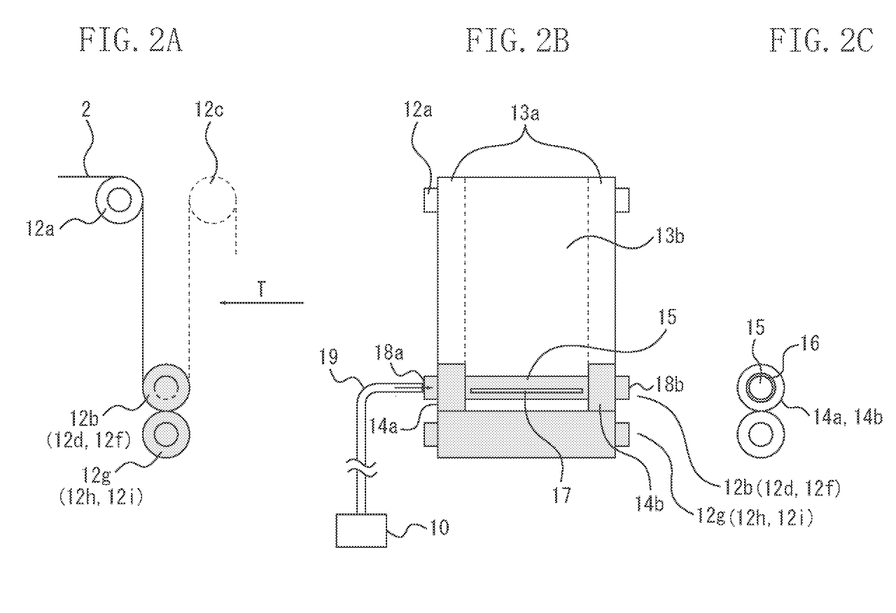

FIGS. 2A to 2C illustrate the medium conveyed inside the dry box 9 in the first exemplary embodiment. FIG. 2A is a side view illustrating the rollers 12a to 12c that constitute the carrier mechanism inside the dry box 9. FIG. 2B is a plan view seen in the direction of an arrow T of FIG. 2A. FIG. 2C is a cross sectional view of the rollers 12b and 12g. The rollers 12b, 12d, and 12f in contact with the surface of the medium have the same configurations. For easy explanation, the rollers are described by way of an example of the roller 12b but the same is true for the other rollers 12d, and 12f.

At both ends of a roller rotation axis of the roller 12b, contact parts 14a and 14b are formed that are in contact with end areas 13a of the conveyed medium 2 where recording is not performed. In other words, the contact parts 14a and 14b are in contact with the medium 2 at the limited areas of both width-directional ends of the medium 2 (direction of the roller rotation axis). An image forming area 13b at a width-directional center area of the medium 2 faces a shaft part 15 of which an outer diameter is smaller than that of the contact parts 14a and 14b of the roller 12b. The shaft part 15 is a non-contact part that is not contact with the medium 2.

As illustrated in FIG. 2C, a bearing 16 is arranged between the shaft part 15 and each of the contact parts 14a and 14b. With this configuration, the contact parts 14a and 14b can independently rotate relative to the fixed shaft part 15. The contact parts 14a and 14b may have crown shaped rollers or inverted crown shaped rollers to prevent the medium 2 from skewing when the medium 2 is conveyed. In addition, the medium 2 may be conveyed by forming holes at the both end areas 13a of the medium 2 at even intervals along the conveyance direction of the medium 2 and inserting a pin into each of the holes.

The shaft part 15 is configured to have a hollow portion inside and one elongated hole (slit) 17 formed on an outer circumferential surface in an axial direction of the roller (width direction of the medium). The outer circumferential surface of the shaft part 15 is a discharge surface with the hole 17 which is formed as a through hole for blowing air out. At both ends of the roller 12b, there are introduction ports 18a and 18b which are formed to introduce hot air into the hollow shaft part 15. A part of a blower port of the hot air blower 10 and either or both of the introductions ports 18a and 18b are connected to each other by a blower tube 19.

FIG. 2B illustrates an example in which the tube 19 is connected to the introduction port 18a. In this case, the introduction port 18b is closed to prevent leakage of the air. A part of hot air generated by the hot air blower 10 is introduced via the tube 19 and from the introduction port 18a into the shaft part 15. Then, the hot air is blown out from the hole 17 formed on the discharge surface of the shaft part 15. At this point, a flow rate of the hot air is 10 L/sec and the temperature is 65° C.

A position and hole direction of the hole 17 are set such that air blow out from the hole 17 is brought toward the print surface of the conveyed medium 2. Thus, the hole 17 is formed just above the roller 12g that the hole 17 faces or at a position slightly displaced therefrom in the circumferential direction of the shaft part 15. When the hole 17 is displaced, it is desirable that its displacement direction is upstream side in the conveyance direction. This is because if the ink is applied to the both end areas 13a of the medium 2, the ink transfer is reduced between the medium 2 and the contact parts 14a, and 14b by blowing the hot air toward the medium 2 before bringing the medium 2 in contact with the contact parts 14a and 14b of the roller 12b.

The configuration described above can be applied to the other rollers 12d and 12f, and in the present exemplary embodiment, the air is blown to the medium 2 by the three rollers to accelerate drying. A number of rollers for blowing the air is not limited to three and may be determined based on the total drying capability.

The shape of the shaft part 15 is not limited to a cylindrical shape. The shaft part 15 may have a hollow structure which has a polygonal cross section. The hole 17 is not limited to the one elongated slit and may be formed of a plurality of holes divided in the width direction or a mesh.

Further, one or a plurality of partial contact parts like the contact parts 14a and 14b may be provided at the midpoint of the shaft part 15 that is non-contact part with the medium. In this case, the hole 17 can be divided into a plurality of the holes by the contact part formed at the midpoint of the shaft part 15. Furthermore, a plurality of the elongated holes 17 may be provided to the shaft part 15 in the circumferential direction thereof. In this case, the position and direction of each slit is determined in such a manner that hot air can be blown from the plurality of holes to the print surface (liquid applied surface) of the medium 2.

The shaft part 15 may be in contact with the roller 12g facing the shaft part 15. In this case, the hole 17 is provided slightly displaced from the position where the shaft 15 is in contact with the roller 12g. It is desirable that the displacement direction is the upstream side in the conveyance direction because the ink transfer is reduced between the medium 2 and the shaft part 15 by blowing the hot air to the medium 2 before the medium 2 is brought into contact with the shaft part 15 at the upstream side.

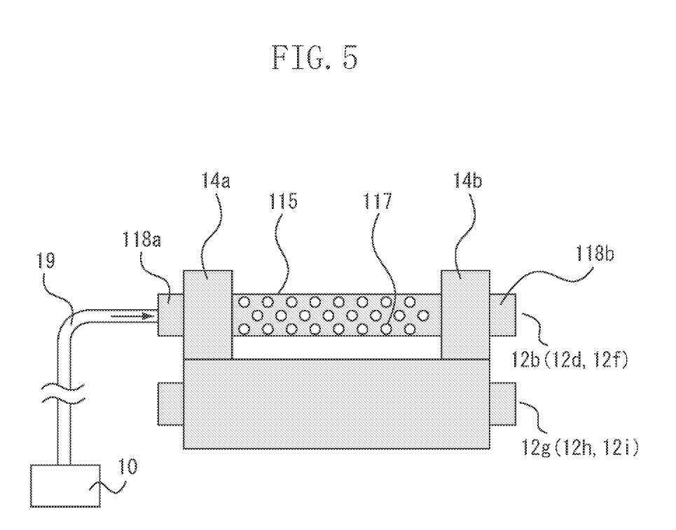

FIG. 5 illustrates another structural example of the roller which blows the air. The roller 12b (same as the rollers 12d and 12f) has contact parts 14a and 14b at both ends thereof like in the example of FIG. 2. A shaft part 115 which is not contact with the medium rotates integrally with the contact parts 14a and 14b. A shaft part 115 has a hollow portion inside and many small holes 117 formed regularly over the whole circumference of an outer circumferential surface thereof (for example, the hole having a diameter of 5 mm). The outer circumferential surface of the shaft part 115 serves as a discharge surface on which a plurality of the small holes 117 as air blowing through holes is formed.

At both ends of the roller 12b, there are introduction ports 118a and 118b which are formed to introduce hot air into the hollow shaft part 115. A part of a blower port of the hot air blower 10 and either or both of the introductions ports 118a and 118b are connected to each other by a blower tube 19. To prevent the introduction ports 118a and 118b from rotating in response to rotation of the roller 12b, a bearing is provided between them.

A part of hot air generated by the hot air blower 10 is introduced via the tube 19 into the shaft part 15. Then, the hot air is blown out from each of the plurality of small holes 27 formed on the discharge surface of the shaft part 115. As the small holes 27 are formed over the circumference of the outer circumferential surface of the shaft part 115, the hot air can be blown toward the medium 2 even when the roller 12b is rotating.

After water evaporated from the image of the medium 2, the evaporated water is discharged via the exhaust portion 11 to the outside. In the dryer 5, the exhaust portion 11 or a wall surface of the dry box 9 is heated to prevent condensation of the vapor according to the ambient temperature and humidity. Besides, a cooling fin may be provided at the exhaust portion 11 to stimulate condensation of the vapor and collect waste water.

In the present exemplary embodiment, the medium suspends inside the dryer and is conveyed along the serpentine path by the plurality of rollers. However, the present invention is not limited to this configuration and the path may be a straight path. In the present exemplary embodiment, the conveyance rollers are arranged with a vertical positional relation. However, they may be arranged with a horizontal positional relation.

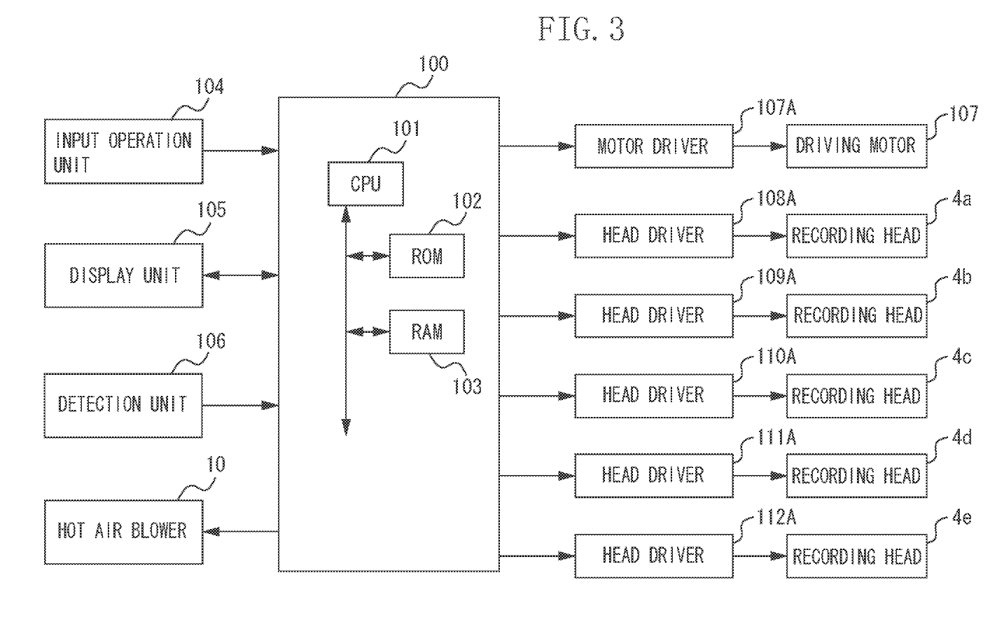

FIG. 3 is a block diagram illustrating a control unit of the image forming apparatus according to the first exemplary embodiment. The control unit 100 controls various operations of the entire image forming apparatus. The control unit 100 includes a central processing unit (CPU) 101, a read only memory (ROM) 102 which stores control programs and the like, and a random access memory (RAM) 103 which temporarily stores data during an operation of the CPU 101 and input data.

The control unit 100 is connected to an input operation unit 104 which includes a keyboard and various switches configured to input given commands and data, a display unit 105 configured to display a status of the image forming apparatus 1, and a detection unit 106 configured to detect the status inside the image forming apparatus 1. Further, the control unit 100 is connected to the hot air blower 10 to control operations of a heater and a blowing fan of the hot air blower 10. The control unit 100 controls a driving motor 107 via a motor driver 107A. The control unit 100 controls the recording heads 4a to 4e via head drivers 108A to 112A.

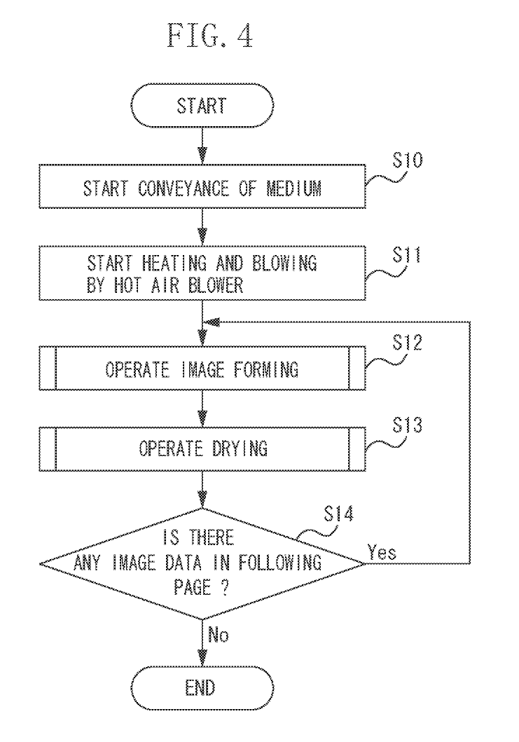

FIG. 4 is a flow chart illustrating a processing procedure of the image forming apparatus according to the first exemplary embodiment. These sequences are executed by control of the control unit 100.

In step S10, when an image forming command is input by receiving image data from outside of the image forming apparatus, the supply roll 2a, the winding roll 2b and the like are rotated to move the medium 2 in the direction indicated by the arrow P of FIG. 1.

In step S11, the heater of the hot air blower 10 is heated and the blowing fan is operated. In step S12, the reaction liquid is applied from the recording head 4a to the conveyed medium 2 and inks are supplied according to image data from the recording heads 4b to 4e to the area where the reaction liquid is applied, so that an image is formed. At this time, the reaction liquid discharged in advance onto the medium 2 and the inks discharged later are brought into contact and mixed to form a cohesive ink image. On the medium 2, the image is formed in which beading or breeding is prevented from occurring.

In step S13, the area of the medium 2 where the image is formed is conveyed into the dry box 9. As a result, water in the reaction liquid and inks evaporates.

In step S14, it is determined whether there is another image data in a following page. When it is determined that there is another image data in the following page (YES in step S14), the procedure returns to step S12 and image forming of the next page is performed. When there is no other image data page (NO in step S14), heating and blowing of the hot air blower 10 are stopped, driving of each roller is also stopped and the procedure ends.

According to the present exemplary embodiment, the hot air is blown locally to the image forming area 13b of the medium 2 where the inks and reaction liquid are applied. Therefore, the hot air blower can be effectively used and drying ink can be accelerated.

Further, there is need to provide, near the conveyance roller, a supply chamber having a discharge port for locally blowing air like the conventional image forming apparatus, the present exemplary embodiment can achieve downsizing and cost cutting of the apparatus. As no supply chamber is provided, the plurality of rollers with discharge surfaces can be arranged at high density, and thus the drying efficiency can be improved. As a result, there is provided an image forming apparatus capable of drying, for a short time, a medium which gets wet in image forming while suppressing increase in the size and cost of the apparatus.

As the roller 12b and the medium 2 are in contact with each other only at the both end areas 13a, and there is a gap between the shaft part 15 as the non-contact part and the medium 2. Air can flow through this gap and air which contains water can easily get out of the space. Hence, drying can be accelerated more.

Besides, as air is blown at a part where the moving sheet-shaped medium is inverted, the air blown to the medium 2 flows along a bent surface of the medium, so that, not only the directly-blown surface part but also the areas of the medium 2 upstream and downstream sides thereof can be dried efficiently.

Further, as the both ends areas 13a of the medium 2 are pressed by the contact parts 14a and 14b, and the rollers are not in contact with the image forming area 13b where the inks are applied, there is no possibility that a trace of the roller remains on the image on the medium.

According to the present exemplary embodiment, in the configuration which applies inks from the recording heads to form an image, the image can be formed with extended definition, at high speed and without damage on the image formed on the medium. Further, a medium can be obtained without cockling.

As described above, the present exemplary embodiment has been described by way of the example of image forming on the medium 2 by inkjet type recording heads. However, the present invention is not limited to the image forming apparatus using the inkjet type recording head. The present invention may be applied to a liquid development type image forming apparatus which uses a photosensitive sheet as the medium 2. More specifically, an image is directly drawn on the photosensitive sheet and exposed to energy such as a laser beam to form a latent image, then the latent image is developed by the liquid development process. In this case, a developer is applied to the medium in the liquid development process and in the later drying process, the above-described drying part is applied. As there is no difference between the inkjet system and the liquid development system in applying liquid to the medium in the image forming and the need for drying it for a short time, the present invention is effectively applied to any embodiment.

An image forming apparatus according to a second exemplary embodiment of the present invention forms an intermediate image by applying inks from recording heads on a transfer belt and transfers the intermediate image from the transfer belt to the medium. After the intermediate image is formed and before it is transferred, the inks applied to the transfer belt are dried by the dryer to a suitable extent for transferring.

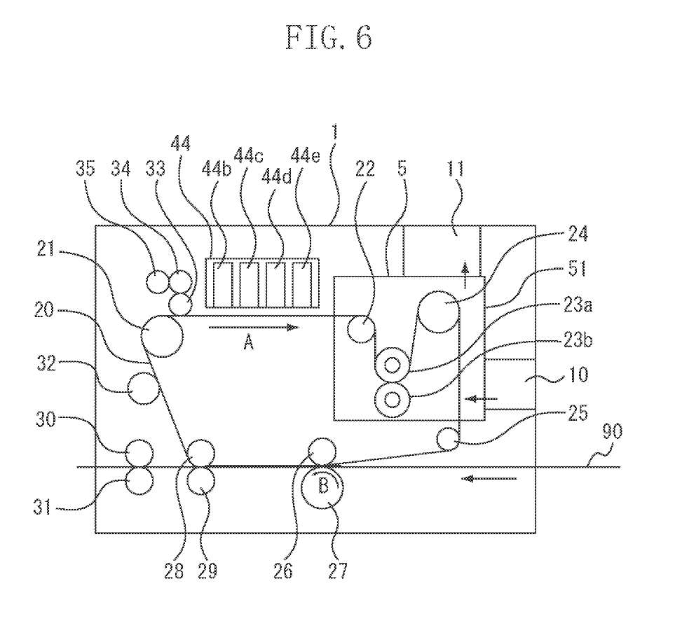

FIG. 6 illustrates the image forming apparatus according to the second exemplary embodiment of the present invention. Members and units which are same as or similar to those in FIG. 1 are denoted by the same reference numerals. A transfer belt 20 is an intermediate transfer member having a release type surface layer in which the surface layer of silicon rubber is laminated around a support member which has same material composition as those of a blanket used in offset printing. The surface layer is subjected to surface treatment so that reaction liquid can be applied to the surface at the thickness of about 1 to 10 μm. More specifically, the silicon surface is subjected to plasma treatment to be hydrophilic.

The transfer belt 20 has a width of 500 mm, of which 50 mm areas at both sides are non-image forming areas. The transfer belt 20 is stretched and driven by rollers 22, 23, and 24 inside the drier 5 and rollers 21, 25, 26 and 28 outside the drier 5 to move in the direction of an arrow A in FIG. 6. Along the moving direction of the transfer belt 20, a reaction liquid applying unit, an image forming unit, the dryer 5, a transfer roller 27, and a cleaning roller 32 are arranged.

The reaction liquid applying unit applies to the transfer belt the reaction liquid for cohering colorants of the inks. An applying roller 33 applies the reaction liquid to the transfer belt 20 and supply rollers 34 and 35 supply the reaction liquid to the applying roller 33. The reaction liquid is supplied from a reaction liquid supply tank (not shown) to the supply roller 35. Then, the reaction liquid is applied to the transfer belt 20 via the supply roller 34 and the applying roller 33.

The image forming unit includes inkjet recording heads 44b to 44e and forms an intermediate image on the transfer belt 20 by applying inks to the transfer belt 20 over the reaction liquid which has been applied.

The dryer 5 includes a dry box 51 with an inlet port and an outlet port for the conveyed transfer belt, the hot air blower 10, and the exhaust portion 11. Further, the dryer 5 includes rollers 22, 23a, 23b, and 24 configured to convey the transfer belt 20 in the dry box 51. In the dry box 51, the transfer belt moves a serpentine path. The length of the transfer belt in the dry box is about 2.5 m. Water evaporated from the transfer belt 20 in the dry box 51 is discharged from the dry box 51 via the exhaust portion 11 to the outside of the image forming apparatus 1.

The rollers 23a and 23b of the dryer 5 have the same configurations as those illustrated in FIG. 3 or 6 described above, and hot air is blown from the discharge surface of the roller 23a toward a belt surface of the transfer belt 20 on which the intermediate image is formed. Drying capability of the dryer 5 is adjusted in such a manner that wetness of the intermediate image on the transfer belt 20 is adequate for transferring after the transfer belt 20 has passed through the dryer 5.

The transfer belt 20 passing through the dryer 5 is then held, together with a medium 90, by a transfer roller 27 and a roller 26, so that the intermediate image on the transfer belt 20 is transferred onto the medium 90 and an image is formed on the medium 90.

The cleaning roller 32 is rotated and driven by the transfer belt 20. The cleaning roller 32 is configured to clean any residual ink and dust adhered to the transfer belt 20 by coming into contact with the transfer belt 20.

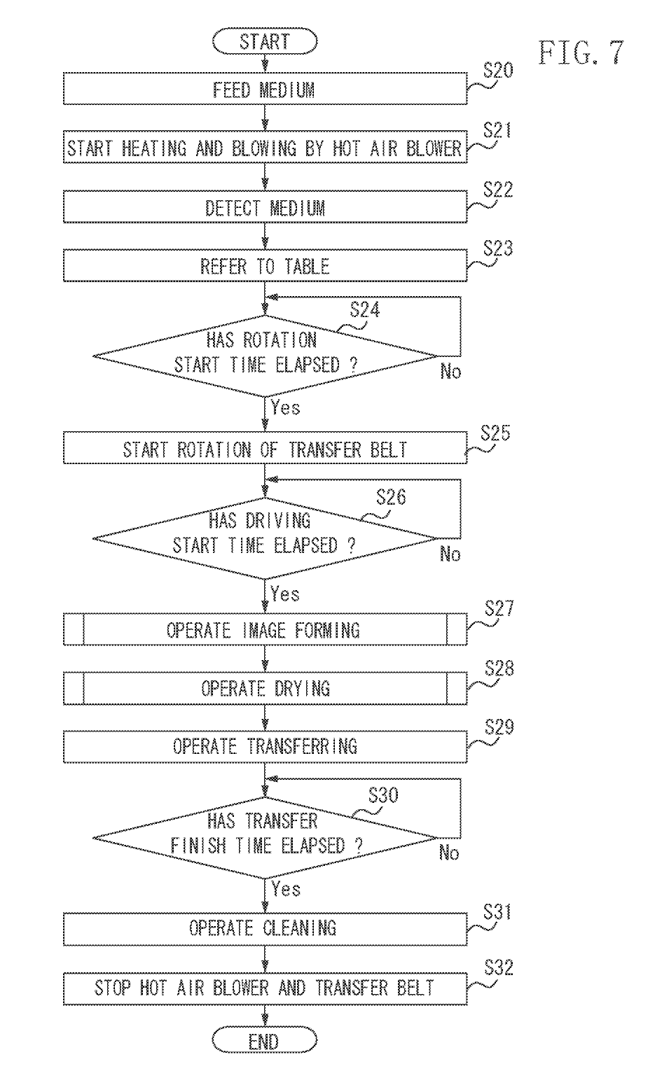

FIG. 7 is a flow chart illustrating the processing procedure of the image forming apparatus according to the second exemplary embodiment. These sequences are executed by control of a control unit same as that described with reference to FIG. 3.

In step S20, when an image forming command is input by receiving image data from outside of the image forming apparatus or the like, the medium 90 is fed from a cassette (not shown). In step S21, a heater of the hot air blower 10 is heated and a blowing fan is operated. In step S22, a sensor provided on the upstream side of the transfer roller 27 determines whether the medium has passed through a predetermined position.

In step S23, a rotation start time of each roller, a driving start time of the recording heads 44b to 44e and a transferring finish time of an ink image from the transfer belt 20 to the medium 40 are obtained with reference to a data table stored in advance in a memory. The rotation start time is a time when a front edge of the image formed on the transfer belt 20 and the medium 40 overlap at a nip portion of the transfer roller 27 and the transfer belt 20.

In step S24, it is determined whether the rotation start time has elapsed. When it is determined that the rotation start time has elapsed (Yes in step S24), the procedure proceeds to step S25. In step S25, each roller is rotated to rotate the transfer belt 20 in the direction of the arrow A of FIG. 6 and the transfer roller 27 is rotated in the direction of an arrow B of FIG. 6.

In step S26, it is determined whether the driving start time has elapsed. When it is determined that the driving start time has elapsed (Yes in step S26), the procedure proceeds to step S27. In step S27, the reaction liquid is applied to the rotating transfer belt 20 by the applying roller 33. Then, the recording heads 44b to 44e discharge inks to the area on which the reaction liquid is applied according to image data and form an intermediate image on the transfer belt 20. At this time, the reaction liquid first applied to the transfer belt 20 and the inks later applied thereto are brought into contact and mixed to form a cohesive ink image. On the transfer belt 20, the image is formed in which occurrence of beading or breeding is prevented.

In step S28, the area of the transfer belt 20 in which the intermediate image is formed passes through the dry box 51. Accordingly, water in the intermediate image evaporates adequately. In step S29, the transfer belt 20 and the medium 90 pass through the nip portion between the transfer roller 27 and the roller 26 while they overlap one another. Then, the intermediate image on the transfer belt 20 is transferred onto the medium 90, so that the image is formed on the medium 90.

In step S30, it is determined whether the transferring finish time has elapsed. When it is determined that the transferring finish time has elapsed (Yes in step S30), the procedure proceeds to step S31. In step S31, the cleaning roller 32 is brought into contact with the transfer belt 20 to clean the surface of the transfer belt 20.

Instep S32, when the cleaning operation is finished, heating and blowing of the hot air blower 10 are stopped, rotation of the transfer belt 20 is stopped and then, the procedure is finished.

According to the second exemplary embodiment, there is provided an image forming apparatus capable of drying, for a short time, a transfer belt which gets wet in image forming while suppressing increase in the size and cost of the apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-286724 filed Nov. 7, 2008, which is hereby incorporated by reference herein in its entirety.

What is claimed is:

1. An image forming apparatus comprising:
an image forming unit configured to form an image by using liquid;
a conveyance mechanism having a roller configured to convey a medium on which the image is formed by the image forming unit or a transfer belt for transferring to a medium an intermediate image formed by the image forming unit, and
wherein the roller has a discharge surface on which one or a plurality of holes is formed to blow gas toward the medium or the transfer belt conveyed by the conveyance mechanism.

2. The image forming apparatus according to claim 1, further comprising:
a tube which is connected to a hollow portion inside the roller, wherein hot air is introduced via the tube into the hollow portion, and then, blown out of the discharge surface through the holes.

3. The image forming apparatus according to claim 2, further comprising:
a dry box configured to enclose the conveyance mechanism;
a hot air blower configured to generate hot air; and
an exhaust portion configured to discharge air from the dry box.

4. The image forming apparatus according to claim 1, wherein the conveyance mechanism comprises a plurality of the rollers arranged along a path and each of the rollers includes the discharge surface.

5. The image forming apparatus according to claim 1, wherein the hole is an elongated slit formed in a width direction of the roller.

6. The image forming apparatus according to claim 1, wherein the roller includes a contact part that is in contact with the medium or the transfer belt and a non-contact part that is not in contact with the medium or the transfer belt, and the discharge surface is provided at the non-contact area.

7. The image forming apparatus according to claim 6, wherein the roller includes a fixed shaft part and the contact part which is rotatable relative to the shaft part, and the shaft part is the non-contact part.

8. The image forming apparatus according to claim 1, wherein the hole is formed at a position above another roller which faces the roller or at a position displaced circumferentially on an upstream side in a conveyance direction.

9. The image forming apparatus according to claim 1,
wherein the image forming unit includes an inkjet type recording head and performs image forming by applying an ink from the recording head directly to the medium, and
wherein after image forming, the gas is blown to the medium.

10. The image forming apparatus according to claim 1,
wherein the image forming unit includes an inkjet type recording head and performs image forming by applying an ink from the recording head to the transfer belt to form the intermediate image and transfers the intermediate image from the transfer belt to the medium, and
wherein after forming of the intermediate image and before transferring, the gas is blown to the transfer belt.

11. The image forming apparatus according to claim 1, wherein the image forming unit performs image forming on the medium by a liquid development system and after a liquid development process, the gas is blown to the medium.
